(19) United States
(12) Patent Application Publication
(10) Pub. No.: US 2010/0021818 A1
(43) Pub. Date: Jan. 28, 2010

(54) HYDROGEN STORAGE MATERIAL, ELECTROCHEMICALLY ACTIVE MATERIAL, ELECTROCHEMICAL CELL AND ELECTRONIC EQUIPMENT

(75) Inventors: Emile Franciscus Maria Josephus Van Thiel, Eindhoven (NL); Petrus Henricus Notten, Eindhoven (NL); Paul Vermeulen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/441,585

(22) PCT Filed: Sep. 20, 2007
(86) PCT No.: PCT/IB07/53818

§ 371 Date: Mar. 17, 2009

(30) Foreign Application Priority Data
Sep. 21, 2006 (EP) 06121017.5

(51) Int. Cl. H01M 4/58; C22C 23/00; C22C 30/00

(52) U.S. Cl. 429/218.2; 420/407; 420/580

(57) ABSTRACT

The invention relates to a hydrogen storage material comprising an alloy of magnesium. The invention further relates to an electrochemically active material and an electrochemical cell provided with at least one electrode comprising such a hydrogen storage material. Also, the invention relates to electronic equipment comprising such an electrochemical cell.

### FIELD OF THE INVENTION

The invention relates to a hydrogen storage material comprising an alloy of magnesium. The invention also relates to a device for the storage of hydrogen gas comprising such a hydrogen storage material. The invention further relates to an electrochemically active material and an electrochemical cell provided with an electrode comprising such a hydrogen storage material. Also, the invention relates to electronic equipment comprising such an electrochemical cell.

### BACKGROUND OF THE INVENTION

Li-ion and Nickel-Metal Hydride (NiMH) batteries are used in numerous electrical devices, in particular in electronic equipment such as portable telephones, laptops, shavers, and power tools. Because the energy consumption of present portable equipment is growing steadily, improved NiMH batteries are required which are able to store a larger amount of energy without resulting in a weight increase. A large group of metal alloys can react with hydrogen reversibly to form metal hydrides, but only a few of them are suitable for hydrogen storage. The alloy must react and release hydrogen readily at moderate pressure and temperature, and must be stable to maintain its reactivity and capacity over a large number of cycles. A known group adapted to serve as a hydrogen storage material can be represented by the formula AB₅, wherein A and B are metal elements. Examples of AB₅-type hydrogen storage alloys are MmNi_{3.5}Co_{0.7}Al_{0.7}Mn_{0.1}, MmNi_{3.6}Co_{0.7}Mn_{0.4}Al_{0.3}, SrTiO₃—LaNi_{3.76}Al_{1.24}Hn, La_{0.8}Ce_{0.2}Ni_{4.25}Co_{0.5}Sn_{0.25}, MmNi_{3.6}Co_{0.7}Al_{0.6}Mn_{0.1}, and LaNi₅. The capacity of a metal hydride (MH) electrode comprising an AB₅-type alloy is currently about 300 mAh/g.

For some time now research has been directed to hydrogen storage materials with improved properties. There has been some interest in magnesium as a hydrogen storage material, but magnesium has the disadvantage that charging and discharging only occur at acceptable rates at elevated temperatures from approximately 300° C.

It is an object of the present invention to provide an improved hydrogen storage material based on magnesium.

### SUMMARY OF THE INVENTION

This object can be achieved by providing a hydrogen storage material comprising an alloy of magnesium, at least one element A and at least one element B, wherein element A is a transition element and element B is an element with a hydride heat of formation higher than magnesium hydride. Such an alloy yields an increased hydrogen partial pressure compared to magnesium or to magnesium alloys comprising only a transition element A and not an element B. Also, such materials have a relatively high energy per weight density. It is necessary to use an alloy of magnesium rather than pure magnesium, as at room temperature (20-25° C.), magnesium charged with hydrogen yields a hydrogen partial pressure that is too low to enable an efficient energy output. In contrast, the alloy according to the invention has a sufficiently high hydrogen partial pressure at room temperature. For element A, in particular elements with a tendency to form a fluorite crystal structure are useful and hence preferable. Also preferred are transition elements A from the first transition series, which yield hydrogen storage materials with a high gravimetrical energy density. Multiple kinds of transition element A may be used as a mixture in the alloy. Preferably, elements B have a hydride heat of formation typically higher than −10 kJ/mol H, and may even have a positive heat of formation. In contrast, the heat of formation of pure magnesium hydride (MgH₂) is −37 kJ/mol H. The hydrides formed by the elements B are labelled as covalent hydrides, however these elements B do not necessarily form covalently bound hydrides within the magnesium alloy. Most covalent hydrides have a positive heat or only slightly negative heat of formation at 1 bar hydrogen pressure. The hydrogen storage material according to the invention may be charged with hydrogen involved in an electrochemical reaction, and/or with gaseous hydrogen (H₂).

Element B yields an improvement of the attainable partial hydrogen pressure of the hydrogen-loaded alloy when compared to the same alloy consisting of only magnesium and an element A. Instead of a single element B, also a mixture of several elements B may be used. In a preferred embodiment, the alloy comprises at least 50 mol % magnesium, at least 0.1 mol % element A and at least 0.1 mol % element B. Herein, the molar percentages formed by the molar fraction×100%, are relative to the total molar amount of magnesium, element A and element B. For instance, the alloy may comprise at least 50 mol % magnesium, at least 0.1 mol % titanium and at least 0.1 mol % aluminium More preferably, the alloy comprises at least 50 mol % magnesium, at least 1 mol % element A and at least 1 mol % element B. Preferably, the sum of the molar percentages of magnesium element A, and element B is lesser than or equal to 100 mol %, wherein it is noted that the alloy may additionally comprise elements other than magnesium, element A, and element B. The hydrogen storage material according to the invention is preferably prepared by a method comprising the process step of formation of an alloy from predetermined amounts of magnesium, at least one element A and at least one element B, wherein element A is a transition element and element B is an element capable of forming a covalent hydride. The formation of an alloy is preferably carried out by means of at least one technique selected from the group consisting of electron-beam deposition, melt spraying, melt spinning, splat cooling, vapour quenching, gas atomisation, plasma spraying, due casting, ball-milling, sputtering and hydrogen induced powder formation.

It is preferred if element A comprises at least one transition element selected from the group consisting of scandium, vanadium, titanium, and chromium. Use of these elements A commonly provides the best hydrogen charging and discharging behaviour. Most preferably, the element A is titanium. The use of titanium in the magnesium alloy shows excellent hydrogen charge and discharge properties. Also, titanium has a relatively low weight, enabling a relatively high gravimetrical energy density in the hydrogen-charged alloy (the amount of energy that can be stored per weight unit of alloy).

It is preferred if element B comprises at least one element selected from the group consisting of aluminium, boron, carbon and silicon, gallium, and germanium. In this preferred embodiment, both charging and discharging of hydrogen from the magnesium alloy will occur relatively easily and quickly. Alloys containing more than one element B selected from the group consisting of aluminium, boron, carbon and silicon, gallium, and germanium also have this property. All these elements are in principle capable of forming a covalent hydride as a separate compound. Preferably, element B is aluminium, silicon or a mixture of aluminium and silicon. Alloys according to the invention comprising aluminium and/or silicon yield the most advantageous hydrogen charge and discharge properties. Another advantage of aluminium and silicon is that these elements are relatively harmless to the environment.

Most preferably, the element A is titanium and element B is aluminium, silicon or a mixture of aluminium and silicon. An alloy made out of magnesium and titanium mixed with aluminium and/or silicon can be reflected as MgₓTi_{y}Al_{z}, MgₓTi_{y}Si_{z} and MgₓTi_{y}Al_{z1}Si_{z2}, respectively, wherein x, y, z, z1 and z2 are the relative molar (or atomic) amounts of the respective elements in the alloy. The alloy according to the invention may also contain additional elements in addition to Mg, Ti, Al and/or Si.

In a preferred embodiment, the alloy comprises at least 50 mol % magnesium. Such alloys have a good hydrogen storage capacity. Preferably, the alloy comprises from 50 to 90 mol % magnesium. The rate capability drops dramatically in alloys with an atomic fraction higher than 90 mol % magnesium with respect to the total amount of magnesium, element A and element B. It is noted that in the range below 90 mol % magnesium the alloy according to the invention has an advantageous fluorite crystal structure that enables such high rates, and that a rutile-structure with less advantageous hydrogen transport characteristics becomes more dominant in alloys with a high magnesium content.

It is advantageous if the alloy comprises at least 0.1 mol % element A, preferably at least 1 mol % element A, and more preferably at least 10 mol % element A. Such alloys have the best rate capability of charging and discharging hydrogen. Most preferably, the alloy comprises element A in an amount of from 15 mol % to 25 mol %. Although the rate capability of the alloy according to the invention appears to behave linear with the fraction of element A in the range higher than 25 mol % of element A, an unexpected increase in rate capability that deviates from the otherwise linear behaviour of the rate capability is observed in the range from 15 mol % to 25 mol % of element A.

In a preferred embodiment, the alloy comprises at least 0.1 mol % element B, preferably at least 1 mol % element B, and more preferably at least 10 mol % element B. Such alloys have a good hydrogen storage capacity as well as a good charging and discharging rate capability. In a preferred embodiment, the alloy comprises magnesium and element B in a molar ratio of from 50:1 to 2:1, most preferably from 10:1 to 4:1. These alloys have a balance between good hydrogen storage capacity as well as a good charging and discharging rate capability.

It is advantageous if the alloy comprises a fluorite crystal structure. A fluorite crystal structure yields higher hydrogen charge and discharge rate capabilities than the rutile structure that is common in pure magnesium.

The invention relates to a device for the storage of hydrogen gas comprising a hydrogen storage material according to the invention. Such a device may for instance be incorporated in hydrogen-fuelled vehicles.

The invention also provides an electrochemically active material, characterized in that the material comprises a hydrogen storage material according to the invention. Such electrochemically active materials may be used in numerous electrical applications. A particular example is the use of the hydrogen storage material as an electrode material.

The invention further relates to an electrochemical cell comprising an electrode, the electrode comprising an electrochemical active material according to the invention. Electrochemical cells commonly comprise at least a positive electrode and a negative electrode. Preferably the negative electrode comprises a hydrogen storage material according to the invention. Such an electrochemical cell may for instance be used for the effective generation of electrical power from hydrogen.

The invention moreover relates to electronic equipment powered by at least one electrochemical cell according to the invention. Such an electrochemical cell enables lightweight devices, such as rechargeable batteries useable in mobile equipment such as cell phones, electronic organizers and laptops. Another application is as a hydrogen storage medium in mobile or stationary applications, in particular fuel cell-driven electric vehicles.

### DETAILED DESCRIPTION OF EMBODIMENTS

The invention will now be elucidated by the following non-restrictive examples.

### Example

Thin films of Mg₅₅Ti₃₀Al₁₅, Mg₆₀Ti₃₀Al₁₀, Mg₆₈Ti₂₂Si₁₀ and Mg₆₉Ti₂₁Al₁₀ were prepared by means of high vacuum deposition (base pressure 10⁻⁷ mbar). The thin films, with a thickness of 200 nm (nominally), were deposited on quartz substrates (20 mm diameter), which were thoroughly cleaned beforehand using an in-house procedure. Cap layers of 10 nm Pd were deposited on top of the thin films in order to protect the films against oxidation and to catalyze hydrogen absorption and hydrogen release.

Uniformity of composition throughout the entire film was checked by means of Rutherford Backscattering Spectroscopy (RBS), which showed that the deposition rates of the individual elements were controlled well. Furthermore, X-ray diffraction was used to identify the crystallographic phases of the as-deposited films.

Calculations of the hydrogen content in the thin films are solely based on the RBS measurements, of which the accuracy is around 1%. It should be noted that no correction is made for the Pd cap layer, as the amount of hydrogen in the Pd can never account for a deviation of this value that exceeds 3%.

Electrochemical measurements were performed using a three-electrode electrochemical cell, thermostated at 298 K by means of a water jacket surrounding the cell, filled with 6 M KOH electrolyte in which the thin film acted as working electrode (active surface area of 3 cm²). The thin films were contacted with a silver wire, which was attached using a conductive adhesive. A chemically inert isolating lacquer was applied to the contacts and the edges of the substrate shielding them from the electrolyte. The potential of the working electrode was measured with respect to a Hg/HgO reference electrode filled with 6 M KOH solution. This reference electrode was placed very close to the working electrode in order to minimize the Ohmic drop caused by the electrolyte.

The counter electrode, a palladium rod, was placed in a separate compartment in the cell and care was taken that the total area in contact with the electrolyte was sufficiently large. The compartments, which held both the working and counter electrode, were separated by means of fritted glass. In a separate setup the counter electrode was pre-charged with hydrogen (PdHₓ). The total amount of charge needed to extract all the hydrogen from this palladium rod far exceeded the charge needed to fully hydrogenate the thin film working electrode. This ensured that during the electrochemical experiments no oxygen was produced at the palladium counter electrode. Argon gas, which was first led through an oxygen scrubber, was used before and during the measurements in order to de-aerate the setup.

Galvanostatic Intermittent Titration Technique (GITT) was used to measure the electrochemical response that is related to the hydrogen insertion into and hydrogen extraction from the alloy. After each current pulse, the thin film was allowed to equilibrate for 1 hour. The current applied during each pulse was 100 mA/g. Coulomb counting was used to determine the gravimetric storage capacity.

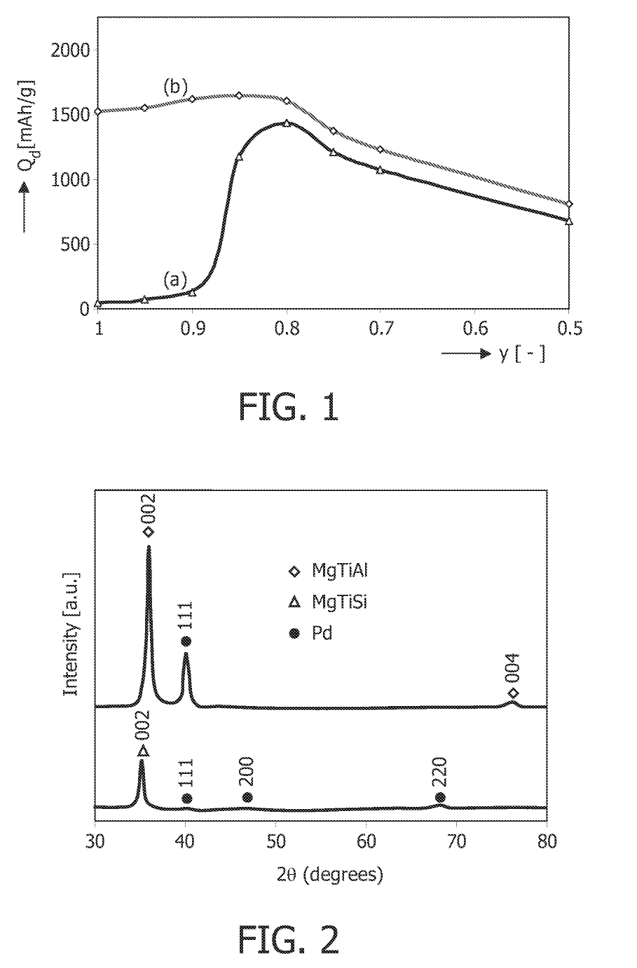

The effect of the Ti-content on the rate capability of Mg_{y}Ti_{(1-y)} alloys with 0.50≦y≦1.0 upon discharging the fully hydrogenated film with a high rate (1000 mA/g; curve (a)) and subsequently low rate current (100 mA/g; curve (b)) is depicted in FIG. 1, showing discharge capacities (Qd) for Mg_{y}Ti_{(1-y)} electrodes with varying composition. Comparable results are obtained for alloys wherein magnesium is partially replaced with an element capable of forming a covalently bound hydride, such as aluminium, for instance the alloys Mg₅₅Ti₃₀Al₁₅, Mg₆₀Ti₃₀Al₁₀, Mg₆₈Ti₂₂Si₁₀ and Mg₆₉Ti₂₁Al₁₀.

A similar compositional dependence of the discharge capacity (Qd) for Mg_{y}Sc_{(1-y)} alloys was found in the paste. There, it was argued that the crystal structure of the hydride induces the hydrogen transport characteristics to change dramatically. In more detail, it was found that materials with an Mg-content in the range of 0≦Mg≦80 mol. % have a cubic, fluorite-structure. By increasing the Mg-content beyond 80 mol. %, the kinetics of the hydride decomposition reaction decreases dramatically to very low Q_{d} values for pure Mg. Strikingly, in line with this observation the crystallographic structure was found to change from fluorite to the Mg-familiar rutile-structure. The favourable fluorite structure of the MgSc hydride most likely originates from the fact that the face-centred cubic (fcc) structure of ScH₂ is retained even when Sc is partially substituted by Mg. As TiH₂ is also known to have a fcc-structure, the close analogy between MgSc and MgTi alloys indicates that again the fluorite structure of MgTiHₓ compounds is retained up to 80 mol. % Mg.

The main disadvantage of pure MgTi hydrides is their low hydrogen partial pressure (approx. 7×10⁻⁷ bar). In order to increase the hydrogen partial pressure, the addition of an element which does not form an extremely stable hydride was included within the MgTi lattice. Furthermore to retain the high gravimetrical energy density of MgTi alloys only light-weight elements are promising substitutes. One of the elements satisfying the requirements is Al (heat of formation—4 kJ/mol H for AlH₃). FIG. 2 shows the XRD spectrum of an as-deposited 200 nm thick Mg₅₅Ti₃₀Al₁₅ thin film with 10 nm Pd. It shows that a solid solution of Ti in Mg was formed with a preferential orientation in the [002] direction indicates to a single-phase crystalline alloy. In accordance with these observations, the XRD spectrum of the MgTiSi compound also points to the formation of a single-phase crystalline alloy, however, in this case a somewhat lower intensity was found and hence the relative peak intensity w.r.t. Pd decreases causing more Pd planes to appear in the XRD spectrum. Both XRD spectra show a decreasing lattice constant of the unit cell in comparison with MgTi alloys by addition of Al and Si.

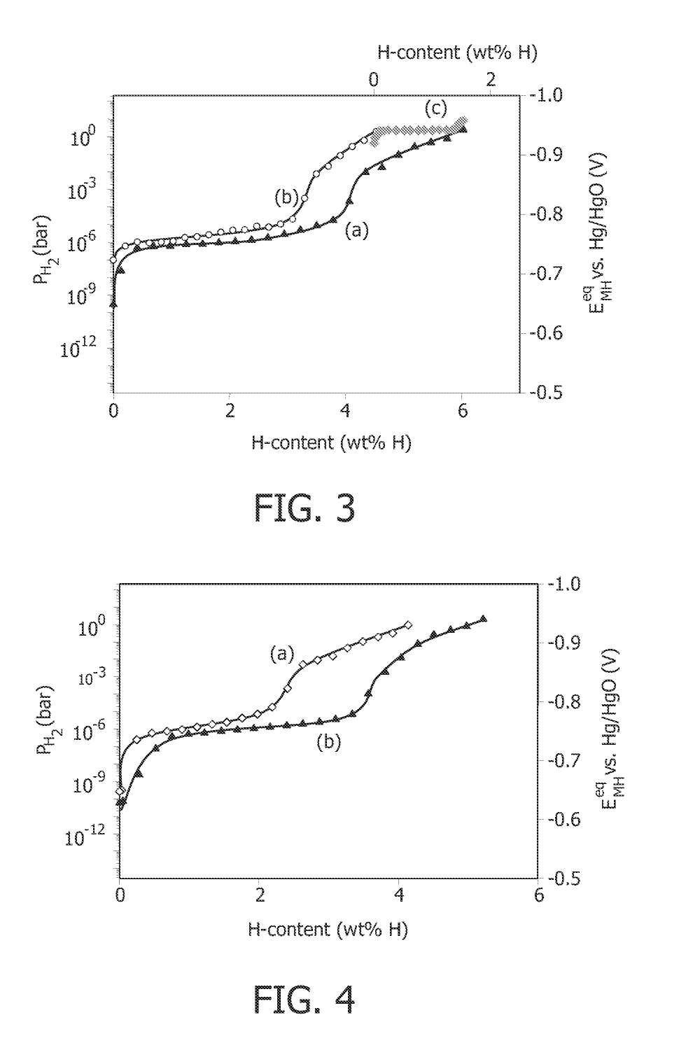

The isothermal curves corresponding to the Mg₆₉Ti₂₁Al₁₀ (curve (a)) and Mg₆₈Ti₂₂Si₁₀ (curve (b) alloys are depicted in FIG. 3. The measurements show a gravimetrical storage capacity of 6.03 wt % for the Mg₆₉Ti₂₂Al₁₀ compound. A gravimetrical storage capacity of 4.53 wt % is obtained for the Mg₆₈Ti₂₁Si₁₀ alloy. Additionally, a very high hydrogen partial pressure, viz. 0.45 bar for Mg₆₉Ti₂₁Al₁₀ and 0.24 bar for Mg₆₈Ti₂₂Si₁₀ on average, is obtained up to approximately 2.2 wt % H and 1.44 wt % H, respectively. In comparison, MischMetal-based AB₅ compounds (curve c) as applied in commercially available Nickel Metal Hydride batteries, are characterized by a high hydrogen partial pressure up to approximately 1.1 wt % hydrogen (top axis corresponds to curve (c)).

The equilibrium curves of Mg₅₅Ti₃₀Al₁₅ (curve (a)) and Mg₆₀Ti₃₀Al₁₀ (curve (b) alloys are depicted in FIG. 4. From the measurements it follows that the gravimetric capacities of Mg₅₅Ti₃₀Al₁₅ and Mg₆₀Ti₃₀Al₁₀ are 4.14 and 5.22 wt. % H, respectively. Additionally, a very high hydrogen partial pressure, viz. 0.16 bar for Mg₅₅Ti₃₀Al₁₅ and 0.40 bar for Mg₆₀Ti₃₀Al₁₀ on average, is obtained during 1.7 wt. % H.

As is shown, it is possible to increase the hydrogen partial pressure of MgTi alloys by the addition of Al. Based on the findings discussed above, also B, C and Si could be used for a similar effect. The heat of formations of the hydrides and the atomic radii of the elements mentioned in this invention disclosure are listed in Tab. 1.

The hydrogen storage materials according to the invention such as the examples Mg₅₅Ti₃₀Al₁₅, Mg₆₀Ti₃₀Al₁₀, Mg₆₈Ti₂₂Si₁₀ and Mg₆₉Ti₂₁Al₁₀, are suitable for various applications, for instance as an electrochemically active material in for instance fuel cells, or in media for the storage of hydrogen gas.

TABLE 1
The heat of formations of the hydrides and atomic radii
of the elements discussed in this invention disclosure.

| | | |
|---|---|---|
| | Heat of Formation | Atomic radius |
| Element | (kJ/mol H) | (pm) |

| | | | |
|---|---|---|---|
| Mg | −37 | (MgH₂) | 150 |
| Sc | −100 | (ScH₂) | 160 |
| Ti | −68 | (TiH₂) | 140 |
| Al | −4 | (AlH₃) | 125 |
| B | −4 | (B₁₀H₁₄) | 85 |
| C | 593 | (CH) | 70 |
| | 193 | (CH₂) | |
| | 72.5 | (CH₃) | |
| | −19 | (CH₄) | |
| Si | 375 | (SiH) | 110 |
| | 144 | (SiH₂) | |
| | 65 | (SiH₃) | |
| | 8 | (SiH₄) | |
| | 12 | (Si₂H₆) | |
| Ga | 224 | (GaH) | 130 |
| | 137 | (GaH₂) | |
| | 50 | (GaH₃) | |
| | 35 | (G₂H₆) | |
| Ge | 23 | GeH₄ | 125 |

1. Hydrogen storage material comprising an alloy of magnesium, at least one element A and at least one element B, wherein element A is a transition element and element B is an element with a hydride heat of formation higher than magnesium hydride.

2. Hydrogen storage material according to claim 1, characterized in that element A comprises at least one transition element selected from the group consisting of scandium, vanadium, titanium, and chromium.

3. Hydrogen storage material according to claim 2, characterized in that element A comprises titanium.

4. Hydrogen storage material according to claim 1, characterized in that element B comprises at least one element selected from the group consisting of aluminium, boron, carbon and silicon, gallium, and germanium.

5. Hydrogen storage material according to claim 4, characterized in that element B comprises aluminium, silicon or a mixture of aluminium and silicon.

6. A hydrogen storage material according to claim 1, characterized in that element A comprises titanium and element B comprises aluminium, silicon or a mixture of aluminium and silicon.

7. Hydrogen storage material according to claim 1 characterized in that the alloy comprises at least 50 mol % magnesium.

8. Hydrogen storage material according to claim 7, characterized in that the alloy comprises from 50 to 90 mol % magnesium.

9. Hydrogen storage material according to claim 1, characterized in that the alloy comprises at least 0.1 mol % element A, preferably at least 1 mol % element A, and more preferably at least 10 mol % element A.

10. A hydrogen storage material according to claim 9, characterized in that the alloy comprises element A in an amount of from 15 mol % to 25 mol %.

11. Hydrogen storage material according to claim 1, characterized in that the alloy comprises at least 0.1 mol % element B, preferably at least 1 mol % element B, and more preferably at least 10 mol % element B

12. A hydrogen storage material according to claim 1, characterized in that the alloy comprises magnesium and element B in a molar ratio of from 50:1 to 2:1.

13. A hydrogen storage material according to claim 12, characterized in that the alloy comprises magnesium and element B in a molar ratio of from 10:1 to 4:1.

14. A hydrogen storage material according to claim 1, characterized in that the alloy comprises a fluorite crystal structure.

15. Device for the storage of hydrogen gas comprising a hydrogen storage material according to claim 1.

16. An electrochemically active material, characterized in that the material comprises a hydrogen storage material according to claim 1.

17. An electrochemical cell provided with an electrode comprising an electrochemically active material according to claim 16.

18. Electronic equipment comprising at least one electrochemical cell according to claim 17.
